(19) United States
(12) Patent Application Publication
(10) Pub. No.: US 2024/0426688 A1
(43) Pub. Date: Dec. 26, 2024

(54) PROCESS PRESSURE TRANSMITTER FOR HYDROGEN APPLICATIONS

(71) Applicant: Rosemount Inc., Shakopee, MN (US)

(72) Inventor: Christopher L. ERIKSEN, Saint Paul, MN (US)

(21) Appl. No.: 18/338,794

(22) Filed: Jun. 21, 2023

(51) Int. Cl. G01L 9/00; G01L 13/02

(52) U.S. Cl. CPC G01L 9/0044; G01L 13/026

(57) ABSTRACT

A process fluid pressure transmitter includes a pressure sensor body containing a pressure sensor that has an electrical characteristic that changes in response to applied pressure. An isolation diaphragm is configured to be exposed to process fluid. A fill fluid fluidically couples the isolation diaphragm to the pressure sensor. A weld ring is welded to the isolation diaphragm at a first weld. A barrier metal is disposed on at least one surface of the isolation diaphragm such that the barrier metal extends over the first weld. The weld ring is welded to the pressure sensor body at a second weld that is spaced from the barrier metal.

### BACKGROUND

In many industrial processes such as paper processing, petroleum refining, and coal processing, it is sometimes desirable to measure a parameter of the process, such as pressure or the level of a process fluid in a container in order to control the process. Process pressure transmitters are generally configured for exposure to a source of process fluid and include a structure, such as a sensing diaphragm, that deforms in response to the process fluid pressure. The deformation of the diagram is measured by a measurement circuit. This may be done by evaluating a strain gauge mounted to the diaphragm, by sensing a change in capacitance from the diaphragm to a wall of a sensing chamber, or any other suitable technique.

The process fluid to which the process pressure transmitter is exposed can be corrosive and/or at elevated temperature. For such applications, many process pressure transmitters include a deflectable isolation diaphragm that is configured to be exposed directly to the process fluid. On an opposite side of the deflectable isolation diaphragm, a substantially-incompressible fill fluid conveys the movement of the deflectable isolation diaphragm to a separate sensing diaphragm.

One challenge for process pressure transmitters occurs when the process fluid includes hydrogen or when the process fluid is hydrogen. The size of the hydrogen molecule allows it to diffuse through thin metal membranes, such as an isolation diaphragm, and can cause a buildup of entrained hydrogen in the fill fluid of the process fluid pressure transmitter. When the process pressure is released, gas dissolved in the fill fluid comes out of solution and creates an observable shift or error in the process fluid pressure transmitter output.

While some attempts have been made to reduce hydrogen diffusion across an isolation diaphragm by providing gold-plating on a surface of the diaphragm, such attempts have only met with some success. As the process industry begins to provide solutions for the hydrogen industry where hydrogen pressures can reach up to 10,000 psi, better solutions are required.

### SUMMARY

A process pressure transmitter includes a pressure sensor body containing a pressure sensor that has an electrical characteristic that changes in response to applied pressure. An isolation diaphragm is configured to be exposed to process fluid. A fill fluid fluidically couples the isolation diaphragm to the pressure sensor. A weld ring is welded to the isolation diaphragm at a first weld. A barrier metal is disposed on at least one surface of the isolation diaphragm such that the barrier metal extends over the first weld. The weld ring is welded to the pressure sensor body at a second weld that is spaced from the barrier metal.

### BRIEF DESCRIPTION OF THE DRAWINGS

FIG. 1 is a diagrammatic view of a process pressure transmitter with which embodiments described herein are particularly useful.

FIG. 2 is a diagrammatic cross sectional view of a pressure sensor housing of a process pressure transmitter with which embodiments described herein are useful.

FIG. 3 is a diagrammatic view of an isolation diaphragm coupled to a weld ring in accordance with one embodiment.

FIG. 4 is a diagrammatic view illustrating the isolator/weld ring subassembly after gold-plating has been applied in accordance with an embodiment of the present invention.

FIG. 5 is a diagrammatic view of an improved gold-plated isolator assembly welded to a pressure sensor module housing in accordance with an embodiment of the present invention.

FIG. 6 is a flow diagram of a method of constructing a process pressure transmitter in accordance with an embodiment of the present invention.

### DETAILED DESCRIPTION OF ILLUSTRATIVE EMBODIMENTS

As set forth above, the emerging hydrogen market is creating a need for new process measurement solutions that are more robust to hydrogen ingress. At high hydrogen pressures, any area of an isolation diaphragm that does not include gold-plating becomes susceptible to hydrogen ingress. However, the manufacturing process for process pressure transmitters that use an isolation diaphragm generally require a weld to seal to and couple the isolation diaphragm to the transmitter. When the weld is performed on a structure that is already plated with gold, it is possible for the weld to become a mixed-metal weld. Gold contamination in a weld is undesirable for many reasons. For example, the gold-contaminated weld will not meet NACE standards and it might not be possible to meet ISO standards.

The Association for Materials Protection and Performance provides standards and certifications with respect to structures and methods that are robust against corrosion. The relevant standards with respect to corrosion are NACE MR0103 and NACE MR0175. “NACE” compliance is commonly referred to as compliance with these two standards. With respect to welding, NACE compliance generally excludes mixed-metal welds. However, providing a process pressure transmitter that is NACE compliant and is able to operate at high hydrogen pressures would provide a significant benefit to the emerging hydrogen process market.

Embodiments described herein generally provide a process pressure transmitter that is suitable for high-pressure hydrogen applications. Moreover, while gold-plating is used in various embodiments herein, NACE compliance is maintained. While embodiments described herein will generally be described with respect to a coplanar process pressure transmitter, embodiments are applicable to any process pressure transmitter that may be exposed to hydrogen.

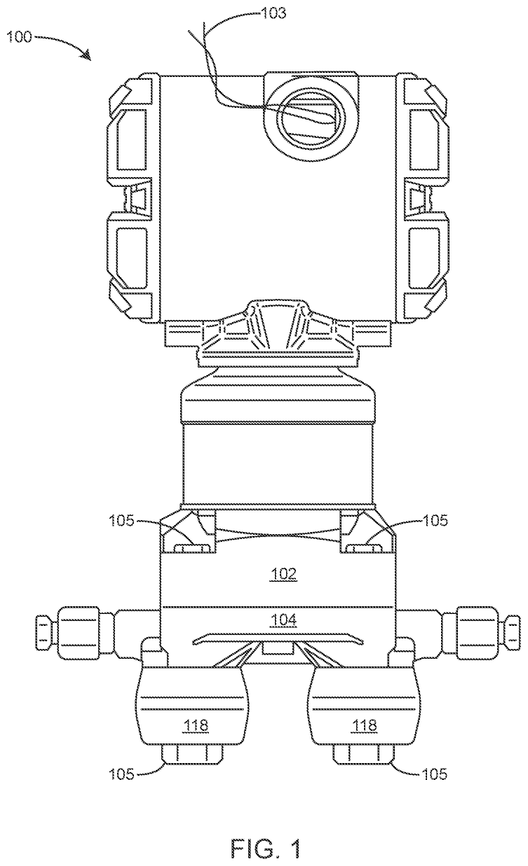

FIG. 1 illustrates a front view of an exemplary coplanar process pressure transmitter 100. Pressure transmitter 100 includes an electronics housing 101 that encloses electronic circuitry and a pressure sensor module housing 102 that houses isolator diaphragms, a pressure sensor and associated sensor circuitry. Pressure sensor module housing 102 is bolted to a pressure flange 104 by bolts 105. The bolts 105 also pass through flange adapter unions 118. Flange adapter unions 118 have threaded inlets which are connectable to threaded process pipes (not illustrated). Pressure flange 104 provides one or more process fluid pressures to the transmitter 100 for pressure measurement. Pressure transmitter 100 is connected to process loop 103 that energizes pressure transmitter 100 and provides communication (preferably bi-directional communication) for use in a process control system.

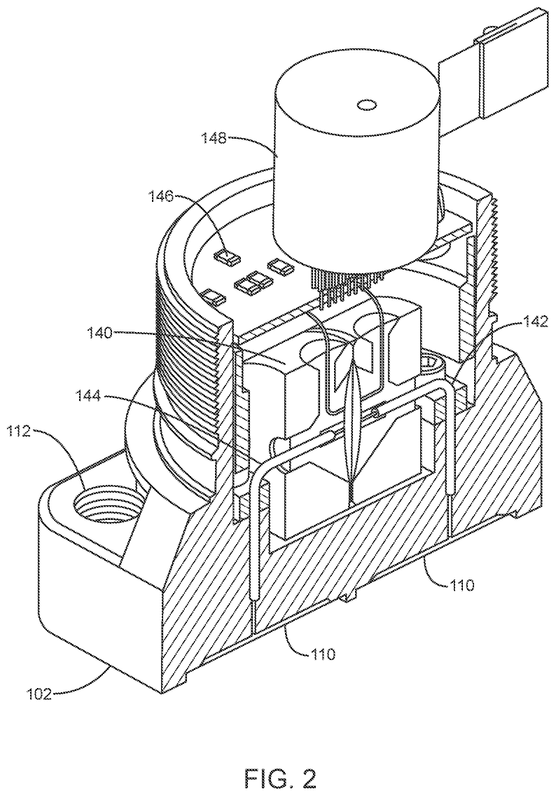

FIG. 2 is a diagrammatic cross-sectional view of a pressure sensor housing of a process pressure transmitter with which embodiments described herein are useful. Pressure sensor module housing 102 includes isolator diaphragms 110 that are welded directly to pressure sensor module housing 102. Housing 102 also includes threaded bolt holes 112 in a standard pattern around isolator diaphragms 110. Differential pressure sensor 140 is located inside pressure sensor module housing 102 and connects, via a substantially incompressible fill fluid within tubes 142, 144, to isolator diaphragms 110. Note, while a differential pressure sensor 140 is shown in FIG. 2, other types of pressure sensor can be used in accordance with embodiment described herein including, an absolute pressure sensor, or a gage pressure sensor. Isolator diaphragms 110 are welded directly to pressure sensor module housing 102. A circuit board 146 provides circuitry associated with processing electrical signals from differential pressure sensor 140. Flat cable reel 148 houses a flat cable that provides electrical connections from circuit board 146 to circuitry in an electronics housing (such as housing 101 shown in FIG. 1).

In accordance with embodiments of the present invention, the design constraints of each portion of the coplanar pressure sensor module are considered individually and tailored for specific needs. While the overall assembly of a coplanar pressure sensor module in accordance with embodiments of the present invention may become more complex than prior designs, such embodiments allow flexibility for different applications, and the ability to reduce costs on certain components, while potentially adding greater structural integrity to other components.

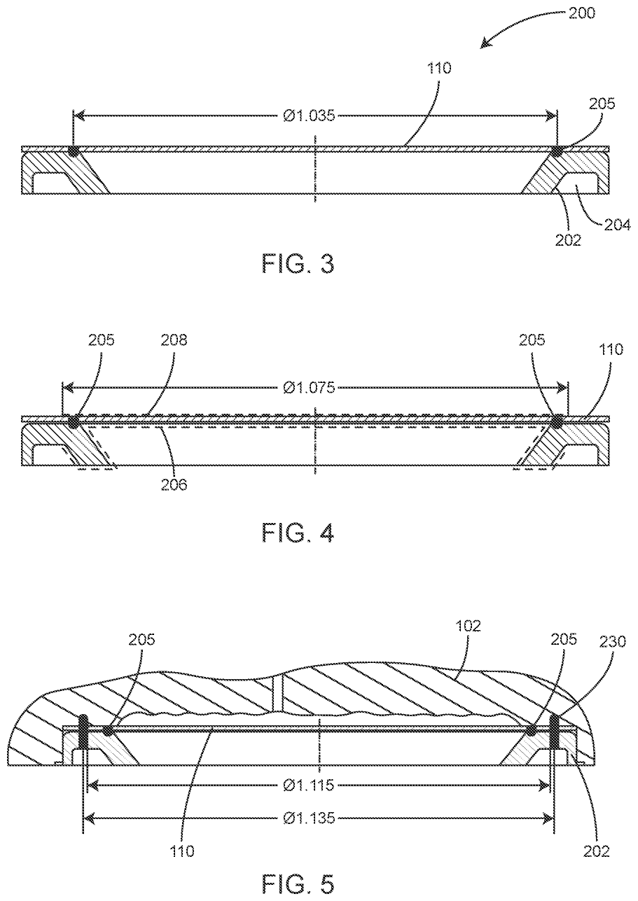

FIG. 3 is a diagrammatic view of an isolation diaphragm coupled to a weld ring in accordance with one embodiment. Isolation diaphragm 110, which may be constructed of any suitable material, is coupled to weld ring 202 at weld 205. Generally, isolation diaphragm 110 is a metallic diaphragm formed of stainless steel, or some other suitable alloy. Similarly, weld ring 202 is also formed of a metal, and is compatible with welding of the isolation diaphragm. In some embodiments, weld ring 202 is also formed of stainless steel. Weld ring 202 generally includes an o-ring recess 204 that is configured to receive an elastomeric o-ring when the pressure sensor module housing 102 is coupled to pressure flange 104. In the example illustrated in FIG. 3, weld 204 is a continuous ring having a diameter of approximately 1.035 inches. While particular dimensions have been shown in order to illustrate an embodiment of the present invention, those skilled in the art will recognize that embodiments can be practiced with other dimensions as well. By providing a continuous ring, not only is isolator diaphragm 110 mechanically coupled to weld ring 202, but it is also fluidically sealed thereto. When isolator diaphragm 110 is so coupled to weld ring 202, the isolator/weld ring subassembly is complete.

FIG. 4 is a diagrammatic view illustrating the isolator/weld ring subassembly after a barrier material, such as gold, has been applied. While embodiments will be described with respect to the barrier material being plated to the isolation diaphragm, it is expressly contemplated that other techniques for depositing the barrier material can be used, such as physical vapor deposition or ion beam deposition. In the illustrated example, gold-plating is represented by phantom lines 206, 208. As shown, gold-plating is provided on all process-wetted surfaces. Further, the gold-plating, in the illustrated example, has a diameter of approximately 1.075 inches. As can be seen, the gold-plating extends beyond the diameter of weld 205. However, gold-plating 206, 208 does not extend across the entire surface of isolator diaphragm 110. Gold-plating 206, 208 is applied to cover substantially the entire isolator surface as well as its attachment weld preferably on both the inside and outside. Note, this structure is relatively easy to mask and plate. Additionally, the gold coverage on both the inside and outside of the isolation diaphragm provides improved scratch resistance, enhanced abrasion robustness, and can even somewhat reduce costs since both surfaces of the isolation diaphragm are plated simultaneously. This provides both a cost and performance benefit. Since both sides of the isolation diaphragm are plated simultaneously, the overall plating thickness grows at double the rate of single-sided plating. This allows plating of an equivalent thickness to grow in half the time, thereby reducing costs by limiting the time in the plating bath. Additionally, the plating structure provides improved robustness to scratch and abrasion, as the inside plating (i.e., the surface exposed to fill fluid) is not directly exposed to the process fluid. Finally, as shown, gold-plating 206, 208 extends over the entire process-wetted surface of isolation diaphragm 110, including its attachment weld 205 on the inside and outside. This plating over the attachment weld 205 effectively reduces the susceptibility of hydrogen embrittlement and permeation of attachment weld to hydrogen. Once the isolator assembly is plated, it is then welded to the pressure sensor module housing 102.

FIG. 5 is a diagrammatic view of an improved gold-plated isolator assembly welded to a pressure sensor module housing in accordance with an embodiment of the present invention. As shown, weld ring 202 is welded to pressure sensor module housing 102 at weld 230. As shown in FIG. 5, the inside diameter of the ring that comprises weld 230 is approximately 1.115 inches. Contrasting that with the maximum diameter of the gold-plating shown in FIG. 4 (1.075 inches) it can be seen that weld 230 does not include any of the gold applied during the gold-plating process. In this way, the only materials fusing in weld 230 are the material of weld ring 202, the material of isolation diaphragm 110, and the material of pressure sensor module housing 102. All of these materials can be specified such the resultant weld is not a mixed-metal weld. Thus, NACE compliance can be maintained even with a robust welded structure while still allowing for significant hydrogen ingress resistance via the utilization of the gold-plating.

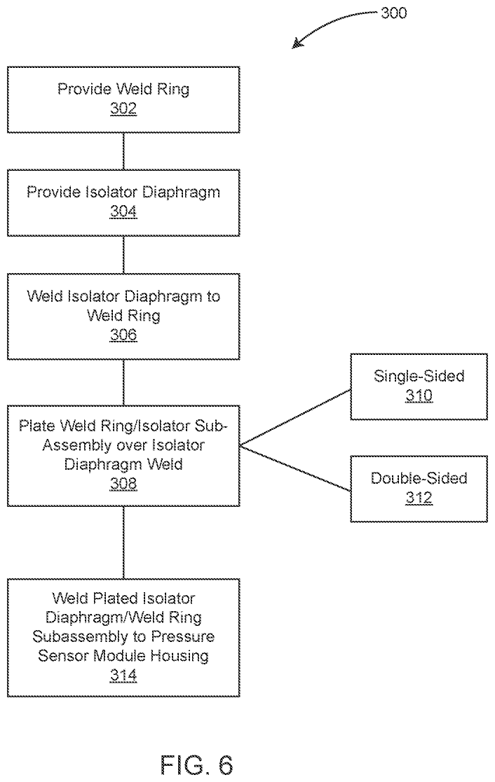

FIG. 6 is a flow diagram of a method of constructing a process pressure transmitter in accordance with an embodiment of the present invention. Method 300 begins at block 302 where a weld ring is provided. Next, at block 304, an isolation diaphragm is provided. At block 306, the isolation diaphragm is welded to the weld ring to form a continuous, sealed, interface between the isolation diaphragm and the weld ring. Next, at block 308, a barrier metal, such as gold, is plated over the weld ring/isolation diaphragm subassembly. This plating preferably does not extend over the entire weld ring/isolator assembly, but must extend over the isolation diaphragm weld (such as weld 205 shown in FIG. 3). The plating may be single-sided, as indicated at block 310, or double-sided for extra protection over hydrogen ingress, as shown in block 312. Next, at block 314, the plated isolation diaphragm/weld ring subassembly is welded to a pressure sensor module housing. This weld is performed in a location where no plated material exists, and in such a way as to be a weld of homogenous metal. Thus, the weld facilitates NACE compliance because it does not introduce any mixed metals. Additionally, in embodiments where the pressure transmitter is a co-planar pressure transmitter, method 300 may be repeated for the second isolator assembly for the process pressure transmitter.

Although the present invention has been described with reference to preferred embodiments, workers skilled in the art will recognize that changes may be made in form and detail without departing from the spirit and scope of the invention.

What is claimed is:

1. A process pressure transmitter comprising:
a pressure sensor body containing a pressure sensor, the pressure sensor having an electrical characteristic that changes in response to applied pressure;
an isolation diaphragm configured to be exposed to process fluid;
a fill fluid fluidically coupling the isolation diaphragm to the pressure sensor;
a weld ring welded to the isolation diaphragm at a first weld;
a barrier metal disposed on at least one surface of the isolation diaphragm, the barrier metal extending over the first weld; and
wherein the weld ring is welded to the pressure sensor body at a second weld that is spaced from the barrier metal.

2. The process pressure transmitter of claim 1, wherein the barrier metal is gold.

3. The process pressure transmitter of claim 1, wherein the barrier metal is plated on the isolation diaphragm.

4. The process pressure transmitter of claim 1, wherein the barrier metal is disposed on both sides of the isolation diaphragm.

5. The process pressure transmitter of claim 4, wherein the barrier metal is gold.

6. The process pressure transmitter of claim 1, wherein the second weld is formed of a homogenous metal.

7. The process pressure transmitter of claim 6, wherein the homogenous metal is different than the barrier metal.

8. The process pressure transmitter of claim 6, wherein the homogenous metal is the same as metal used for the pressure sensor body, isolation diaphragm, and weld ring.

9. The process pressure transmitter of claim 1, wherein the pressure sensor is an absolute pressure sensor.

10. The process pressure transmitter of claim 1, wherein the pressure sensor is a gage pressure sensor.

11. The process pressure transmitter of claim 1, and further comprising:
an additional isolation diaphragm configured to be exposed to process fluid;
an additional volume of fill fluid fluidically coupling the additional isolation diaphragm to the pressure sensor;
an additional weld ring welded to the additional isolation diaphragm at a third weld;
a barrier metal plated to at least one surface of the additional isolation diaphragm, the barrier metal extending over the third weld; and
wherein the additional weld ring is welded to the pressure sensor body at a fourth weld that is spaced from the barrier metal.

12. The process pressure transmitter of claim 11, wherein the pressure sensor is a differential pressure sensor.

13. The process pressure transmitter of claim 12, wherein the process fluid pressure transmitter is a coplanar process fluid pressure transmitter.

14. The process pressure transmitter of claim 1, wherein the process fluid pressure transmitter is NACE compliant.

15. The process pressure transmitter of claim 1, wherein the barrier metal is selected based on the process fluid to which the isolation diaphragm is configured to be exposed.

16. A method of manufacturing a process pressure transmitter for service with a process fluid containing hydrogen, the method comprising:
providing a weld ring;
providing an isolator diaphragm configured to be exposed to the process fluid;
welding the isolator diaphragm to the weld ring at a first location;
coating a barrier metal on the isolator diaphragm, such that the barrier metal extends over the first location; and
welding the weld ring to a pressure sensor body of the process transmitter at a second location that is spaced from the barrier metal.

17. The method of claim 16, wherein coating the barrier metal on the isolator diaphragm includes plating gold onto the isolator diaphragm.

18. The method of claim 17, and further comprising plating gold onto both sides of the isolator diaphragm.

19. The method of claim 18, wherein both sides are plated simultaneously.

20. The method of claim 16, and further comprising:
providing an additional weld ring;
providing an additional isolator diaphragm configured to be exposed to the process fluid;
welding the additional isolator diaphragm to the additional weld ring at a third location;
coating a barrier metal on the additional isolator diaphragm, such that the barrier metal extends over the third location; and
welding the additional weld ring to the pressure sensor body of the process fluid transmitter at a fourth location that is spaced from the barrier metal.

21. The method of claim 20, wherein the process transmitter is a coplanar process fluid transmitter.

22. A pressure transducer comprising:
a pressure sensor having an electrical characteristic that changes in response to applied pressure;
an isolation diaphragm configured to be exposed to process fluid;
a weld ring welded to the isolation diaphragm at a first weld;
a barrier metal disposed on at least one surface of the isolation diaphragm, the barrier metal extending over the first weld;
wherein the weld ring is welded to a pressure sensor body at a second weld that is spaced from the barrier metal; and
wherein the isolation diaphragm is operably coupled to the pressure sensor.
